(19) United States
(12) Patent Application Publication
(10) Pub. No.: US 2021/0011321 A1
(43) Pub. Date: Jan. 14, 2021

(54) DISPLAY DEVICE AND METHOD FOR MANUFACTURING THE SAME

(71) Applicant: Samsung Display Co., Ltd., Yongin-Si (KR)

(72) Inventors: Hwanyoung JANG, Hwaseong-si (KR); Sunkwun SON, Suwon-si (KR); Nahyeon CHA, Yongin-si (KR)

(21) Appl. No.: 16/816,207

(22) Filed: Mar. 11, 2020

(30) Foreign Application Priority Data
Jul. 9, 2019 (KR) 10-2019-0082778

(51) Int. Cl. G02F 1/1339; G02F 1/1337

(52) U.S. Cl. CPC G02F 1/13392; G02F 1/1368; G02F 1/1337

(57) ABSTRACT

A display device according to an embodiment of the present disclosure may include a first substrate, a second substrate, and a sealing member. The first substrate may include a first base layer, a first dam, a second dam, and an organic layer. A first pattern, which is recessed from a top surface of the organic layer, is defined in the top surface of the organic layer, and the first pattern is provided between the first dam and the second dam.

### CROSS-REFERENCE TO RELATED APPLICATIONS

This U.S. non-provisional patent application claims priority under 35 U.S.C. § 119 of Korean Patent Application No. 10-2019-0082778, filed on Jul. 9, 2019, the entire contents of which are hereby incorporated by reference.

### BACKGROUND

The present disclosure relates to a display device having improved reliability and a method for manufacturing the same.

A liquid crystal display device may include a liquid crystal display panel including two substrates, which face each other, with a liquid crystal layer disposed therebetween. The liquid crystal display device may apply a voltage to an electric-field generation electrode and generate an electric-field in the liquid crystal layer. Therefore, an alignment direction of liquid crystal molecules of the liquid crystal layer may be determined, and an image may be displayed by controlling polarization of incident light.

The two substrates of the liquid crystal display device may be bonded by a sealing member with the liquid crystal layer therebetween. An alignment film, which determines an initial alignment direction of the liquid crystal molecules, may be disposed on a surface of each of the two substrates facing the liquid crystal layer.

### SUMMARY

The present disclosure provides a display device having improved reliability and a method for manufacturing the same.

An embodiment of the present disclosure may provide a display device including: a first substrate including a display area in which a plurality of pixels are disposed and a non-display area disposed adjacent to the display area; a second substrate disposed on the first substrate; and a sealing member disposed between the first substrate and the second substrate. Here, the first substrate may includes: a first base layer; a first dam disposed on the first base layer in the non-display area; a second dam disposed on the first base layer in the non-display area and spaced apart from the first dam; and an organic layer disposed on the first base layer. Also, a first pattern, which is recessed from a top surface of the organic layer, may be defined in the top surface of the organic layer, and the first pattern may be provided between the first dam and the second dam.

In an embodiment, the first pattern may include a first sub-pattern and a second sub-pattern, the first sub-pattern may be disposed adjacent to the first dam, the second sub-pattern may be disposed adjacent to the second dam while being spaced apart from the first sub-pattern, and each of the first sub-pattern and the second sub-pattern may be recessed from the top surface of the organic layer.

In an embodiment, the sealing member may overlap the second dam and may not overlap the first dam on a plane.

In an embodiment, the first dam may include a first lower dam and a first upper dam disposed on the first lower dam, and the second dam may include a second lower dam and a second upper dam disposed on the second lower dam.

In an embodiment, the first upper dam may have a width less than a width of the first lower dam, and the second upper dam may have a width less than a width of the second lower dam.

In an embodiment, the first upper dam may have a thickness less than a thickness of the first lower dam, and the second upper dam may have a thickness less than a thickness of the second lower dam.

In an embodiment, the organic layer may have a thickness less than a thickness of the first lower dam.

In an embodiment, a second pattern recessed from the top surface may be defined in the organic layer, and the second pattern may be spaced apart from the first pattern with respect to the second dam.

In an embodiment, the second substrate may include: a second base layer; a first column spacer disposed below the second base layer and overlapping the non-display area on a plane; and a second column spacer disposed below the second base layer and overlapping the non-display area on the plane while being spaced apart from the first column spacer.

In an embodiment, the first column spacer may overlap the first pattern on the plane, and the second column spacer may overlap the second pattern on the plane.

In an embodiment, the first column spacer and the second column spacer may not overlap the first dam and the second dam on the plane.

In an embodiment, the first substrate may further include a first alignment film disposed on the first base layer, and the second substrate may further include a second alignment film disposed below the second base layer.

In an embodiment, the first alignment film may overlap the first dam and the first pattern on the plane and may not overlap the second dam and the second pattern.

In an embodiment, the second alignment film may overlap the first column spacer and may not overlap the second column spacer on the plane.

In an embodiment of the present disclosure, a method for manufacturing a display device includes: providing a first substrate including a display area in which a plurality of pixels are disposed and a non-display area disposed adjacent to the display area; providing a second substrate disposed on the first substrate; and coupling the first substrate and the second substrate by using a sealing member. Here, the providing of the first substrate includes providing a base layer; forming a first dam on the base layer overlapping the non-display area; forming a second dam, which is spaced apart from the first dam, on the base layer overlapping the non-display area; forming an organic layer on the base layer; and patterning the organic layer using a mask. Also, the patterning of the organic layer includes forming a first pattern, which is recessed from a top surface of the organic layer, in the top surface of the organic layer between the first dam and the second dam.

In an embodiment, the sealing member may overlap the second dam and may not overlap the first dam on the plane.

In an embodiment, the patterning of the organic layer may further include forming a second pattern recessed from the top surface of the organic layer, and the second pattern may be spaced apart from the first pattern with respect to the second dam.

In an embodiment, the forming of the first pattern may include forming a first sub-pattern recessed from the top surface of the organic layer adjacent to the first dam; and forming a second sub-pattern recessed from the top surface of the organic layer adjacent to the second dam. Here, the first sub-pattern and the second sub-pattern may be spaced apart from each other.

In an embodiment, the providing of the first substrate may further include forming an alignment film on the organic layer.

In an embodiment, the alignment film may overlap the first dam and the first pattern and may not overlap the second dam.

### BRIEF DESCRIPTION OF THE FIGURES

The accompanying drawings are included to provide a further understanding of the present disclosure, and are incorporated in and constitute a part of this specification. The drawings illustrate example embodiments of the present disclosure and, together with the description, serve to explain principles of the present disclosure. In the drawings:

FIG. 1 is a perspective view illustrating a display device according to an embodiment of the present disclosure;

FIG. 2 is a block diagram illustrating the display device according to an embodiment of the present disclosure;

FIG. 3 is a perspective view illustrating a display panel according to an embodiment of the present disclosure;

FIG. 4 is a cross-sectional view illustrating the display panel according to an embodiment of the present disclosure;

FIG. 5 is a cross-sectional view taken along line I-I′ of FIG. 3;

FIG. 6 is a cross-sectional view taken along line II-II′ of FIG. 3;

FIG. 7 is another cross-sectional view taken along line II-II′ of FIG. 3, which is the corresponding cross-sectional view of FIG. 6;

FIG. 8 is a cross-sectional view illustrating a process of patterning an organic layer according to an embodiment of the present disclosure;

FIGS. 9A and 9B are plan views illustrating a mask according to an embodiment of the present disclosure;

FIG. 10 is a cross-sectional view illustrating a first substrate in which an organic layer is patterned according to an embodiment of the present disclosure;

FIGS. 11A and 11B are plan views illustrating a mask according to an embodiment of the present disclosure; and

FIG. 12 is a cross-sectional view illustrating a first substrate in which an organic layer is patterned according to an embodiment of the present disclosure.

### DETAILED DESCRIPTION

In this specification, it will also be understood that when one component (or region, layer, portion) is referred to as being ‘on’, ‘connected to’, or ‘coupled to’ another component, it can be directly disposed/connected/coupled on/to the one component, or an intervening third component may also be present.

Like reference numerals refer to like elements throughout. Also, in the figures, the thickness, ratio, and dimensions of components are exaggerated for clarity of illustration.

The term “and/or” includes any and all combinations of one or more of the associated listed items.

It will be understood that although the terms such as ‘first’ and ‘second’ are used herein to describe various elements, these elements should not be limited by these terms. The terms are only used to distinguish one component from other components. For example, a first element referred to as a first element in one embodiment can be referred to as a second element in another embodiment without departing from the scope of the appended claims. The terms of a singular form may include plural forms unless referred to the contrary.

Also, “under”, “below”, “above’, “upper”, and the like are used for explaining relation association of components illustrated in the drawings. The terms may be a relative concept and described based on directions expressed in the drawings.

Unless otherwise defined, all terms (including technical and scientific terms) used herein have the same meaning as generally understood by those skilled in the art. Terms as defined in a commonly used dictionary should be construed as having the same meaning as in an associated technical context, and unless defined apparently in the description, the terms are not ideally or excessively construed as having formal meaning.

The meaning of ‘include’ or ‘comprise’ specifies a property, a fixed number, a step, an operation, an element, a component or a combination thereof, but does not exclude other properties, fixed numbers, steps, operations, elements, components or combinations thereof.

Hereinafter, embodiments of the present disclosure will be described with reference to the accompanying drawings.

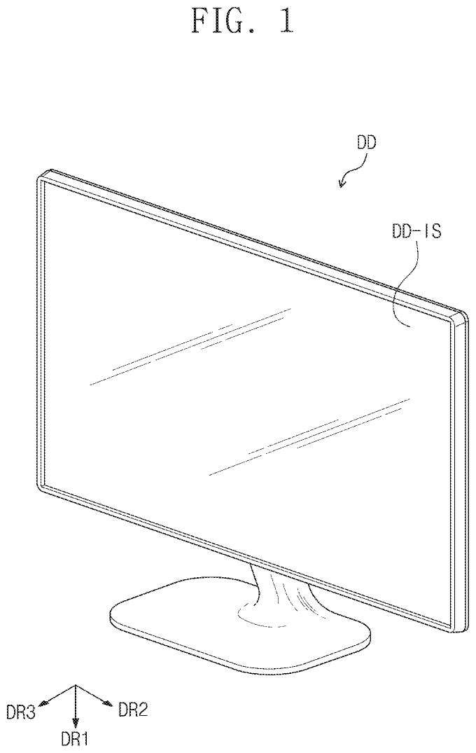

FIG. 1 is a perspective view illustrating a display device according to an embodiment of the present disclosure.

Referring to FIG. 1, a display device DD may display an image through a display surface DD-IS. In FIG. 1, the display surface DD-IS may include a surface defined by a first direction DR1 and a second direction DR2 crossing the first direction DR1.

A thickness direction of the display device DD indicates a third direction DR3. The third direction DR3 crosses each of the first and second directions DR1 and DR2. The first direction DR1, the second direction DR2, and the third direction DR3 may be perpendicular to each other.

Here, directions indicated by the first to third directions DR1, DR2, and DR3 may be a relative concept, and converted with respect to each other. Hereinafter, first to third directions may be indicated by the first to third directions DR1, DR2, and DR3, and designated by the same reference numerals, respectively. Also, in this specification, a surface defined by the first direction DR1 and the second direction DR2 may be defined as a plane, and a feature of “viewing on the plane” may be defined by viewing from the third direction DR3.

The display device DD may be used for large-sized display devices such as televisions, monitors, or outdoor advertisement boards and small and medium-sized display devices such as personal computers, notebook computers, personal digital terminals, navigation units for vehicles, game consoles, portable electronic devices, and cameras. The above-described devices are exemplified as merely an example embodiment, and thus, the display device DD may be adopted for other display devices unless departing from the spirit and scope of the current disclosure.

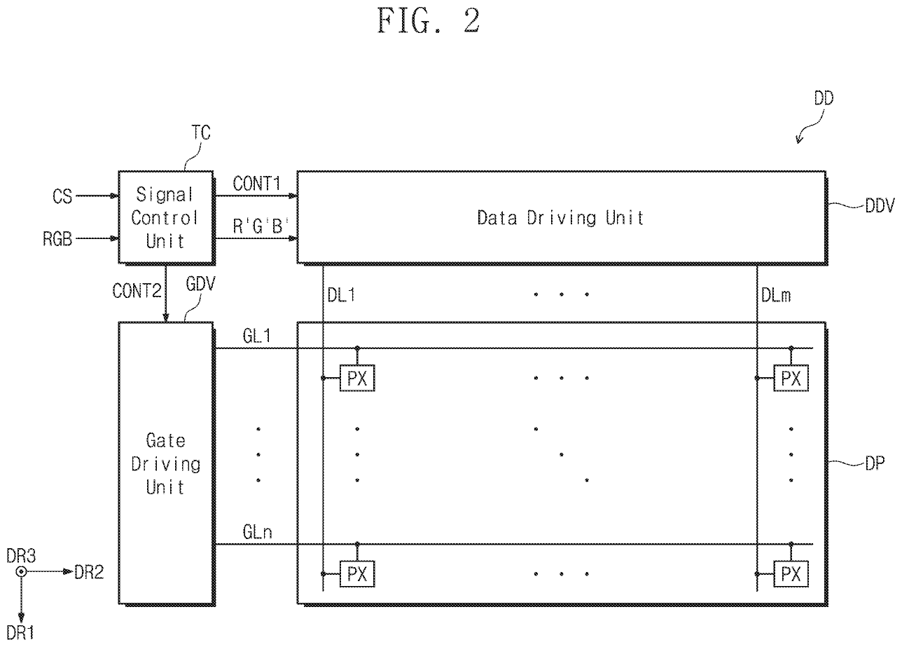

FIG. 2 is a block diagram illustrating the display device according to an embodiment of the present disclosure.

Referring to FIG. 2, the display device DD may include a display panel DP, a signal control unit TC (or timing controller), a data driving unit DDV, and a gate driving unit GDV. The signal control unit TC, the data driving unit DDV, and the gate driving unit GDV may constitute a circuit.

The display panel DP may be a liquid crystal display panel. The display device DD may further include a backlight unit (not shown) providing light to the display panel DP. The display panel DP may control a transmission amount of light generated from the backlight unit to display an image.

The display panel DP may include a plurality of data lines DL1 to DLm, a plurality of gate lines GL1 to GLn, and a plurality of pixels PX.

The plurality of data lines DL1 to DLm may each extend in the first direction DR1 and be arranged in the second direction DR2. The plurality of gate lines GL1 to GLn may each extend in the second direction DR2 and be arranged in the first direction DR1.

The pixels PX may be arranged in the first direction DR1 and the second direction DR2. Each of the pixels PX may display one of primary colors or one of mixed colors. The primary colors may include red, green, and blue. The mixed colors may include various colors such as white, yellow, cyan, and magenta. However, the embodiment of the present disclosure is not limited to the above-described colors.

Each of the pixels PX may include a pixel electrode and a pixel circuit that is electrically connected to the pixel electrode. The pixel circuit may include a plurality of transistors. Each of the pixels PX may be electrically connected to a corresponding gate line of the gate lines GL1 to GLn and a corresponding data line of the data lines DL1 to DLm.

Although a 1 gate line 1 data line (1G1D) structure in which one gate line and one data line are connected to one pixel is illustrated in FIG. 2, the embodiment of the present disclosure is not limited thereto. In another embodiment of the present disclosure, the number of gate lines GL1 to GLn may be reduced by half of that illustrated in FIG. 2. This may be a half gate double data (HG2D) structure. For example, one gate line may be provided for two pixels, which are adjacent to each other. The one gate line may provide the same gate signal to the two pixels that are adjacent to each other in the first direction DR1. Thus, when compared with the 1G1D structure, the time in which the gate signal is provided becomes two times longer. As a result, the time for charging a data voltage may be sufficiently secured.

The signal control unit TC may receive image data RGB provided from the outside. The signal control unit TC may generate a converted data R′G′B′ by converting the image data RGB in correspondence to an operation of the display panel DP and output the converted data R′G′B′ to the data driving unit DDV.

Also, the signal control unit TC may receive a control signal CS provided from the outside. The control signal CS may include a vertical synchronization signal, a horizontal synchronization signal, a main clock signal, and a data enable signal. The signal control unit TC may provide a first control signal CONT1 to the data driving unit DDV and provide a second control signal CONT2 to the gate driving unit GDV. The first control signal CONT1 may control the data driving unit DDV, and the second control signal CONT2 may control the gate driving unit GDV.

The data driving unit DDV may drive the plurality of data lines DL1 to DLm in response to the first control signal CONT1 received from the signal control unit TC. The data driving unit DDV may be realized as an independent integrated circuit and electrically connected to one side of the display panel DP or directly mounted on the display panel DP. Also, the data driving unit DDV may be realized as a single chip or include a plurality of chips.

The gate driving unit GDV may drive the plurality of gate lines GL1 to GLn in response to the second control signal CONT2 received from the signal control unit TC. The gate driving unit GDV may be integrated on a predetermined area of the display panel DP. In this case, the gate driving unit GDV may include a plurality of thin-film transistors provided through a low temperature polycrystalline silicon (LTPS) process or a low temperature polycrystalline oxide (LTPO) process. Also, the gate driving unit GDV may be realized as an independent integrated circuit chip and electrically connected to one side of the display panel DP.

While a gate-on voltage is applied to one of the plurality of gate lines GL1 to GLn, the gate-on voltage may be applied to a corresponding pixel of one row of pixels, which are connected to the one gate line, through a turned-on switching transistor.

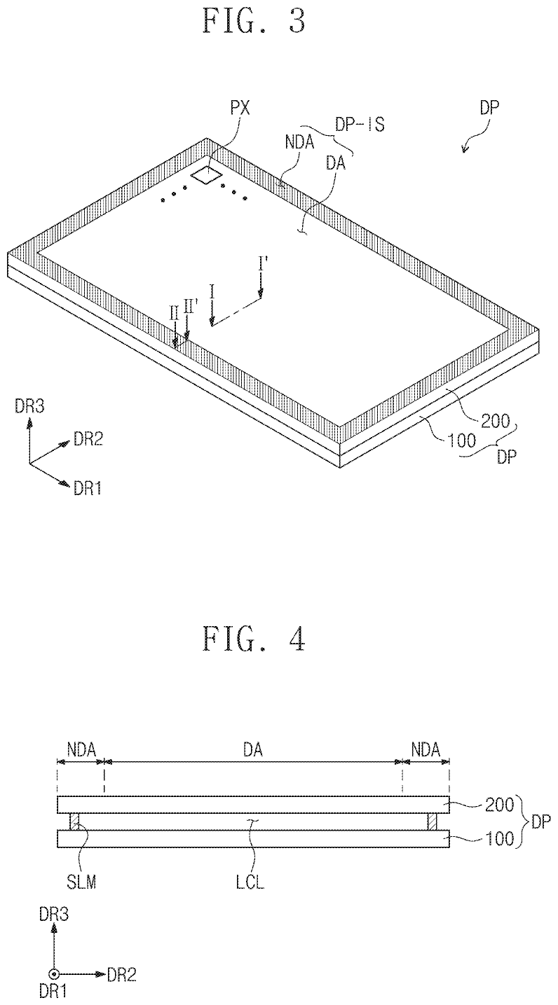

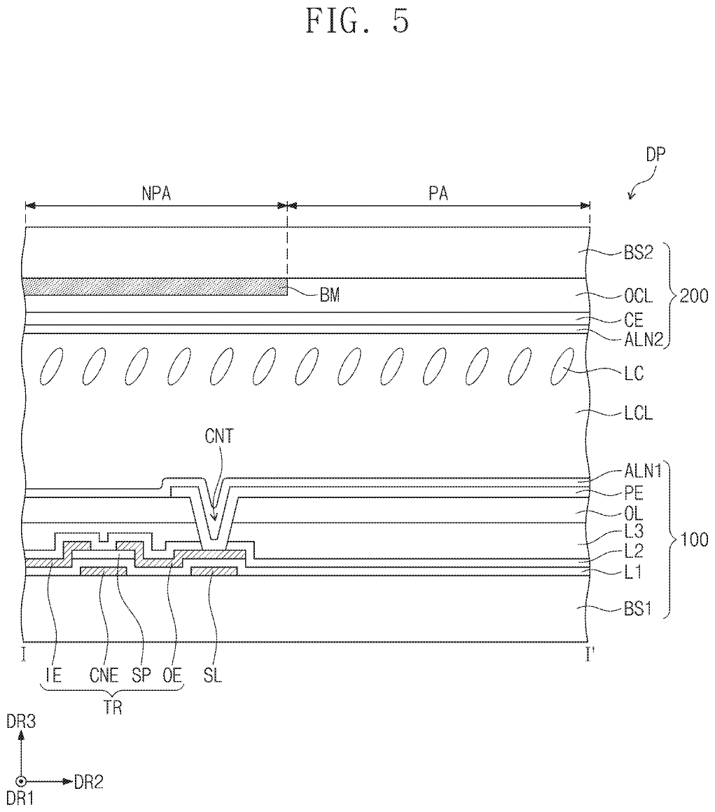

FIG. 3 is a perspective view illustrating the display panel according to an embodiment of the present disclosure, and FIG. 4 is a cross-sectional view illustrating the display panel according to an embodiment of the present disclosure.

Referring to FIGS. 3 and 4, the display panel DP may display an image through a display surface DP-IS. The display surface DP-IS may be parallel to a plane defined by the first direction DR1 and the second direction DR2. The display surface DP-IS of the display panel DP may correspond to the display surface DD-IS of the display device DD. The display surface DP-IS may include a display area DA and a non-display area NDA disposed adjacent to the display area DA. The plurality of pixels PX may be disposed on the display area DA. The plurality of pixels PX (hereinafter, referred to as a pixel) may not be disposed on the non-display area NDA.

The non-display area NDA may be defined along an edge of the display surface DP-IS. The non-display area NDA may surround the display area DA.

The display panel DP may include a first substrate 100 (or a lower substrate) and a second substrate 200 (or an upper substrate) spaced apart from the first substrate 100 while facing the same. A liquid crystal layer LCL may be disposed between the first substrate 100 and the second substrate 200.

A sealing member SLM may be disposed on the non-display area NDA. The sealing member SLM may couple the first substrate 100 and the second substrate 200 to each other. The sealing member SLM may include an organic adhesive member or an inorganic adhesive member.

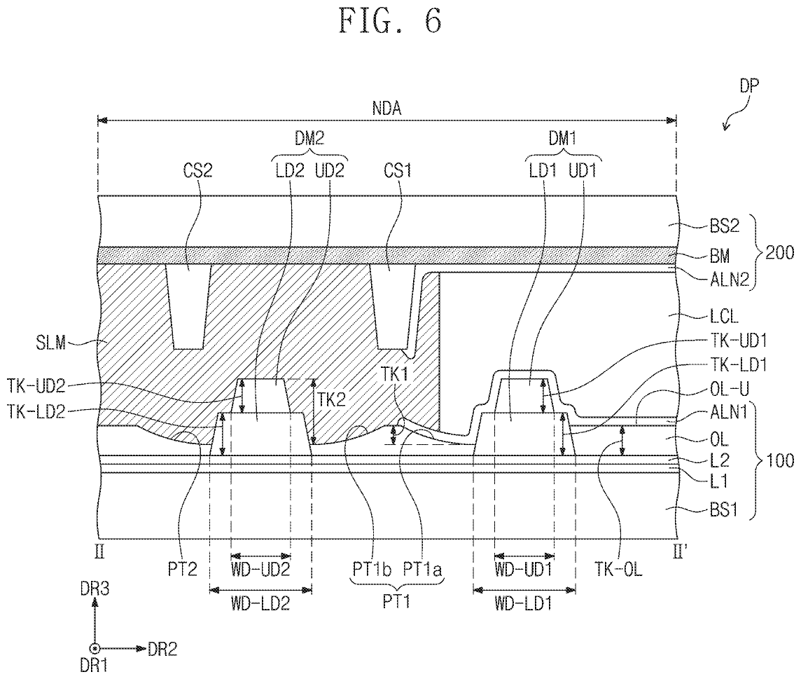

FIG. 5 is a cross-sectional view taken along line I-I′ of FIG. 3.

Referring to FIG. 5, the display panel DP may include the first substrate 100, the second substrate 200, and the liquid crystal layer LCL.

The first substrate 100 may include a first base layer BS1, a transistor TR, a storage line SL, a first insulation layer L1, a second insulation layer L2, a third insulation layer L3, an organic layer OL, a pixel electrode PE, and a first alignment film ALN1.

The first base layer BS1 may be optically clear. Thus, light generated from the backlight unit (not shown) may transmit through the first base layer BS1 and easily reach the liquid crystal layer LCL. The base layer BS1 may include an insulating material. For example, the first base layer BS1 may include a silicon substrate, a plastic substrate, an insulation film, a laminated structure, or a glass substrate. The laminated structure may include a plurality of insulation layers.

The pixel PX (refer to FIG. 4) may be controlled by at least one transistor and at least one capacitor. In FIG. 5, one transistor TR is illustrated.

The transistor TR may include a control electrode CNE, an input electrode IE, an output electrode OE, and a semiconductor pattern SP.

The control electrode CNE may be disposed on the first base layer BS1. The control electrode CNE may include a conductive material. For example, the conductive material may be a metal material such as molybdenum, silver, titanium, copper, aluminum, or an alloy containing the same.

The storage line SL may be disposed on the first base layer BS1. The storage line SL may be provided through the same process as the control electrode CNE. Storage voltage may be provided to the storage line SL. The voltage corresponding to the difference between the pixel voltage provided to the pixel electrode PE and the storage voltage may be charged to the storage capacitor (not shown).

The first insulation layer L1 may be disposed on the first base layer BS1 to cover the control electrode CNE and the storage line SL. That is, the control electrode CNE and the storage line SL may be disposed between the first insulation layer L1 and the first base layer BS1.

A semiconductor pattern SP may be disposed on the first insulation layer L1. On a cross-section, the semiconductor pattern SP may be spaced apart from the control electrode CNE with the first insulation layer L1 therebetween. The semiconductor pattern SP may include a semiconductor material. The semiconductor material may include at least one of amorphous silicon, polycrystalline silicon, monocrystalline silicon, an oxide semiconductor, and a compound semiconductor. An input electrode IE and an output electrode OE may be disposed on the semiconductor pattern SP.

The second insulation layer L2 may be disposed on the first insulation layer L1 to cover the semiconductor pattern SP, the input electrode IE, and the output electrode OE. That is, the semiconductor pattern SP, the input electrode IE, and the output electrode OE may be disposed between the first insulation layer L1 and the second insulation layer L2.

The third insulation layer L3 may be disposed on the second insulation layer L2. The third insulation layer L3 may be a color filter. For example, when the third insulation layer L3 is a red color filter, the third insulation layer L3 may transmit light in a red wavelength range and block light in other wavelength ranges. When the third insulation layer L3 is a blue color filter, the third insulation layer L3 may transmit light in a blue wavelength range and block light in other wavelength ranges. When the third insulation layer L3 is a green color filter, the third insulation layer L3 may transmit light in a green wavelength range and block light in other wavelength ranges. However, the embodiment of the present disclosure is not limited thereto. For example, the third insulation layer may be replaced by a wavelength conversion layer. The wavelength conversion layer may include a quantum dot and/or a quantum rod.

The organic layer OL may be disposed on the third insulation layer L3. The organic layer OL may planarize a top surface of the first substrate 100. When the first alignment film ALN1 is applied, the planarized first substrate 100 may prevent aggregation of the first alignment film ALN1 to prevent stains generated on the display panel DP. The organic layer OL may include an optically clear material.

The pixel electrode PE may be electrically connected to the transistor TR. A contact hole CNT may be defined in the third insulation layer L3 and the organic layer OL. The contact hole CNT may be provided by removing a portion of each of the third insulation layer L3 and the organic layer OL. The contact hole CNT may expose a component disposed below the third insulation layer L3. For example, the contact hole CNT may expose the output electrode OE. The pixel electrode PE may be electrically connected to the output electrode OE that is exposed by the contact hole CNT. The pixel electrode PE may directly contact and be electrically connected to the output electrode OE, or be indirectly connected to the output electrode OE through a conductive member disposed therebetween.

The first alignment film ALN1 may be disposed on the pixel electrode PE and the organic layer OL. The first alignment film ALN1 may determine an alignment of the liquid crystal layer LCL to arrange a plurality of liquid crystal molecules LC. The first alignment film ALN1 may include an organic polymer material. For example, the organic polymer material may include polyimide, polyamic acid, and polysiloxane.

The liquid crystal layer LCL may be disposed on the first alignment film ALN1. The liquid crystal layer LCL may include the plurality of liquid crystal molecules LC. The plurality of liquid crystal molecules LC may be varied in arrangement with respect to an electric field provided between the common electrode CE and the pixel electrode PE

The second substrate 200 may be disposed on the liquid crystal layer LCL. The second substrate 200 may be disposed on the first substrate 100. The second substrate 200 may include a second base layer BS2, a planarization layer OCL, a light shielding part BM, a common electrode CE, and a second alignment film ALN2.

The second base layer BS2 may be optically clear. Thus, light transmitted through the liquid crystal layer LCL may transmit through the second base layer BS2. The second base layer BS2 may include an insulating material. For example, the second base layer BS2 may be a silicon substrate, a plastic substrate, an insulation film, a laminated structure, or a glass substrate. The laminated structure may include a plurality of insulation layers.

The light shielding part BM may be disposed on one surface of the second base layer BS2, which faces the first base layer BS1. The light shielding part BM may overlap the transistor TR on a plane.

An area covered by the light shielding part BM may be defined as a non-light emitting area NPA, and an area that is not covered by the light shielding part BM may be defined as a light emitting area PA. The light transmitted through the liquid crystal layer LCL may be emitted to the outside of the second base layer BS2 through the light emitting area PA.

The planarization layer OCL covering the light shielding part BM may be disposed on one surface of the second base layer BS2, which faces the first base layer BS1. However, the embodiment of the present disclosure is not limited thereto. For example, in an embodiment, the planarization layer OCL may be omitted. The planarization layer OCL may include an organic material. The common electrode may be disposed below the planarization layer OCL.

The second alignment film ALN2 may be disposed below the common electrode CE. The second alignment film ALN2 may face the first alignment film ALN1. The second alignment film ALN2 may determine an alignment of the liquid crystal layer LCL to arrange the plurality of liquid crystal molecules LC. The second alignment film ALN2 may include the substantially same material as the first alignment film ALN1.

FIG. 6 is a cross-sectional view taken along line II-II′ of FIG. 3. The components described through FIG. 5 are designated by the same reference numerals, and description thereof is omitted.

Referring to FIG. 6, a first dam DM1 and a second dam DM2 may be disposed on the second insulation layer L2 of the first substrate 100. The first dam DM1 may be disposed in the non-display area NDA.

The first dam DM1 may include a first lower dam LD1 and a first upper dam UD1. The first dam DM1 may be made of the same material as the third insulation layer L3 (refer to FIG. 5), and the first lower dam LD1 and the first upper dam UD1 may be provided simultaneously through the same process as each other. The third insulation layer L3 (refer to FIG. 5) may include a red color filter, a blue color filter, and a green color filter. For example, the first lower dam LD1 may be a red color filter, and the first upper dam UD1 may be a blue color filter. However, the embodiment of the present disclosure is not limited thereto. For example, each of the first lower dam LD1 and the first upper dam UD1 may be one of the red color filter, the blue color filter, and the green color filter.

The first upper dam UD1 may have a width WD-UD1 less than a width WD-LD1 of the first lower dam LD1. The first upper dam UD1 may have a thickness TK-UD1 less than a thickness TK-LD1 of the first lower dam LD1.

The second dam DM2 may be disposed in the non-display area NDA. The second dam DM2 may be spaced apart from the first dam DM1 in the second direction DR2. The second dam DM2 may include the substantially same material as the first dam DM1. The second dam DM2 may include a second lower dam LD2 and a second upper dam UD2.

The second upper dam UD2 may have a width WD-UD2 less than a width WD-LD2 of the second lower dam LD2. The second upper dam UD2 may have a thickness TK-UD2 less than a thickness TK-LD2 of the second lower dam LD2.

An organic layer OL may be disposed on the second insulation layer L2. The organic layer OL may a thickness TK-OL less than each of the thickness TK-LD1 of the first lower dam LD1 and the thickness TK-LD2 of the second lower dam LD2. A first pattern PT1 may be provided on a top surface OL-U of the organic layer OL. The first pattern PT1 may be provided between the first dam DM1 and the second dam DM2.

The first pattern PT1 may include a first sub-pattern PT1a and a second sub-pattern PT1b. The first sub-pattern PT1a may have a shape recessed from the top surface OL-U of the organic layer OL. The first sub-pattern PT1a may be adjacent to the first dam DM1. The organic layer OL on which the first sub-pattern PT1a is provided may have a thickness that gradually increases in a direction away from the first dam DM1 in the second direction DR2. The organic layer OL having the first sub-pattern PT1a may have an inclined surface in the second direction DR2. The inclined surface may be inclined with respect to a plane that is parallel to the first direction DR1 and the second direction DR2.

The second sub-pattern PT1b may has a shape recessed from the top surface OL-U of the organic layer OL. The second sub-pattern PT1b may be adjacent to the second dam DM2. The organic layer OL on which the second sub-pattern PT1b is provided may have a thickness that gradually increases in a direction away from the second dam DM2 in the second direction DR2. The organic layer OL having the second sub-pattern PT1b may have an inclined surface in the second direction DR2. The inclined surface may be inclined with respect to a plane that is parallel to the first direction DR1 and the second direction DR2.

A second pattern PT2 may be provided on the top surface OL-U of the organic layer OL. The second pattern PT2 may be spaced apart from the first pattern PT1 with respect to the second dam DM2 therebetween. The second pattern PT2 may have a shape recessed from the top surface OL-U of the organic layer OL. The second pattern PT2 may have a thickness that gradually increases in a direction away from the second dam DM2 in the second direction DR2. The organic layer OL having the second pattern PT2 may have an inclined surface in the second direction DR2. The inclined surface may be inclined with respect to a plane parallel to the first direction DR1 and the second direction DR2.

The first alignment film ALN1 may be disposed on the organic layer OL. The first alignment film ALN1 may overlap the first dam DM1 and the first pattern PT1 on a plane. The first alignment film ALN1 may not overlap the second dam DM2 and the second pattern PT2 on the plane.

According to an embodiment of the present disclosure, the thickness difference TK1 between the maximum thickness and the minimum thickness of the first sub-pattern PT1a overlapping the non-display area NDA serves as a dam to prevent the first alignment film ALN1, which passes over the first dam DM1, from passing over the second dam DM2. The area in which the first alignment film ALN1 and the sealing member SLM overlap each other on the plane may not pass over the second dam DM2. The adhesive force between the first alignment film ALN1 and the sealing member SLM may be less than that between the organic layer OL and the sealing member SLM. Thus, an adhesive force between the sealing member SLM and each of the first and second substrates 100 and 200 may be prevented from being reduced. On the plane, a gap may not be generated between the first alignment film ALN1 and the sealing member SLM. Thus, internal permeation of air or moisture, which is able to be generated through the gap, may be prevented. Thus, the display device DD (refer to FIG. 1) having improved reliability may be provided.

Although the first alignment film ALN1 passes over the first sub-pattern PT1a, as the thickness difference TK2 between a thickness of the second dam DM2 and the minimum thickness of the second sub-pattern PT1b serves as an additional dam, the first alignment film ALN1 may not pass over the second dam DM2.

A first column spacer CS1 and a second column spacer CS2 may be disposed below the light shielding part BM of the second substrate 200. The first column spacer CS1 may be disposed in the non-display area NDA. The first column spacer CS1 may overlap the first pattern PT1 on the plane.

The second column spacer CS2 may be disposed in the non-display area NDA. The second column spacer CS2 may be spaced apart from the first column spacer CS1 in the second direction DR2. The second column spacer CS2 may overlap the second pattern PT2 on the plane.

The first column spacer CS1 and the second column spacer CS2 may not overlap the first dam DM1 and the second dam DM2 on the plane. On the plane, when the first column spacer CS1 overlaps the first dam DM1 or the second column spacer CS2 overlaps the second dam DM2, the plurality of liquid crystal molecules LC (refer to FIG. 5) may be blocked by the first column spacer CS1 and the first dam DM1 or the second column spacer CS2 and the second dam DM2 and thus not be evenly distributed.

The second alignment film ALN2 may be disposed below the light shielding part BM. The second alignment film ALN2 may overlap the first column spacer CS1 on the plane. The second alignment film ALN2 may not overlap the second column spacer CS2 on the plane.

According to an embodiment of the present disclosure, as the first column spacer CS1 overlapping the non-display area NDA serves as a dam, the second alignment film ALN2 may be prevented from passing over the first column spacer CS1. The area in which the second alignment film ALN2 and the sealing member SLM overlap each other on the plane may not pass over the second column spacer CS2. The adhesive force between the second alignment film ALN2 and the sealing member SLM may be less than that between the light shielding part BM and the sealing member SLM. Thus, the adhesive force between the sealing member SLM and each of the first and second substrates 100 and 200 may be prevented from being reduced. On the plane, a gap may not be generated between the second alignment film ALN2 and the sealing member SLM. Thus, internal permeation of air or moisture, which is able to be generated through the gap, may be prevented. Thus, the display device DD (refer to FIG. 1) having improved reliability may be provided.

Although the second alignment film ALN2 passes over the first column spacer CS1, as the second column spacer CS2 serves as an additional dam, the second alignment film ALN2 may be prevented from passing over the second column spacer CS2.

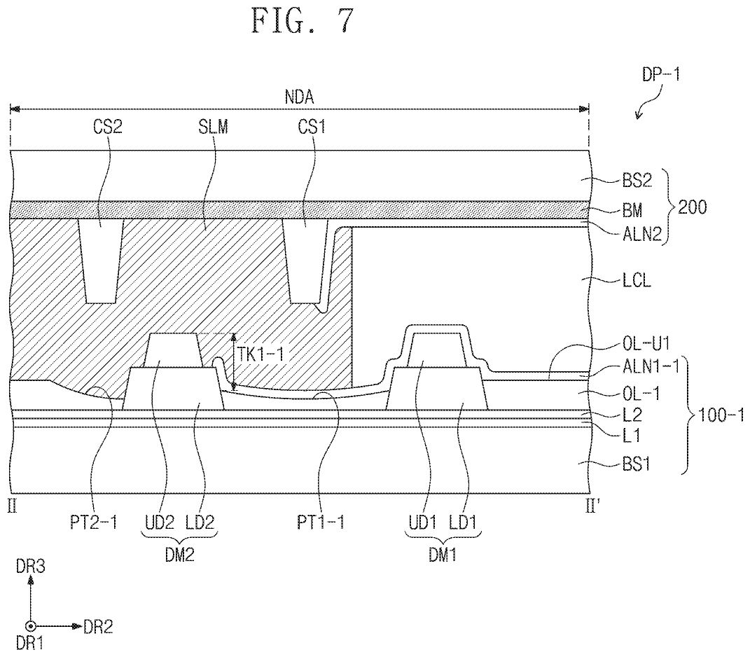

FIG. 7 is another cross-sectional view taken along line II-II′ of FIG. 3, which is the corresponding cross-sectional view of FIG. 6. The components described through FIG. 6 is designated by the same reference numerals, and description thereof is omitted

Referring to FIG. 7, a display panel DP-1 may include a first substrate 100-1, a second substrate 200, and a sealing member SLM. An organic layer OL-1 may be disposed on a second insulation layer L2 of the first substrate 100-1. A first pattern PT1-1 may be provided on a top surface OL-U1 of the organic layer OL-1. The first pattern PT1-1 may be provided between the first dam DM1 and the second dam DM2. The first pattern PT1-1 may have a shape recessed from the top surface OL-U1 of the organic layer OL-1.

A second pattern PT2-1 may be provided on the top surface OL-U1 of the organic layer OL-1. The second pattern PT2-1 may be spaced apart from the first pattern PT1-1 with respect to the second dam DM2 therebetween. The second pattern PT2-1 may have a shape recessed from the top surface OL-U1 of the organic layer OL-1. The second pattern PT2-1 may have a thickness that gradually increases in a direction away from the second dam DM2.

A first alignment film ALN1-1 may be disposed on the organic layer OL-1. The first alignment film ALN1-1 may overlap the first dam DM1 and the first pattern PT1-1 on a plane.

According to an embodiment of the present disclosure, the thickness difference TK1-1 between a thickness of the second dam DM2 overlapping the non-display area NDA and the maximum thickness of the first pattern PT1-1 serves as a dam to prevent the first alignment film ALN1, which passes over the first dam DM1, from passing over the second dam DM2. The area in which the first alignment film ALN1-1 and the sealing member SLM overlap each other on the plane may not pass over the second dam DM2. The adhesive force between the first alignment film ALN1-1 and the sealing member SLM may be less than that between the organic layer OL-1 and the sealing member SLM. Thus, the adhesive force between the sealing member SLM and each of the first and second substrates 100-1 and 200 may be prevented from being reduced. On the plane, a gap may not be generated between the first alignment film ALN1-1 and the sealing member SLM. Thus, internal permeation of air or moisture, which is able to be generated through the gap, may be prevented. Thus, the display device DD (refer to FIG. 1) having improved reliability may be provided.

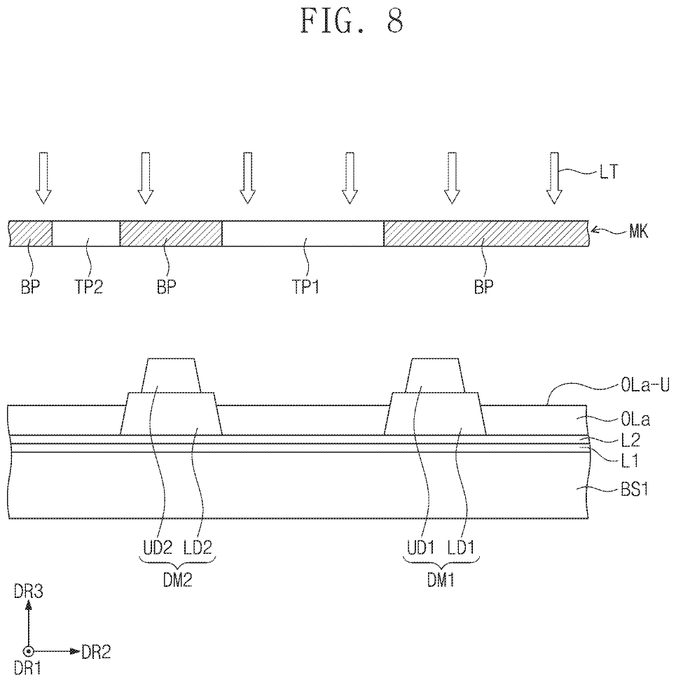

FIG. 8 is a cross-sectional view illustrating a process of patterning an organic layer according to an embodiment of the present disclosure.

Referring to FIG. 8, an organic layer OLa may be formed on a second insulation layer L2. The organic layer OLa may provide a flat top surface OLa-U. The organic layer OLa may include an optically clear material. The organic layer OLa may include a positive photosensitive material. However, the embodiment of the present disclosure is not limited thereto. For example, in an embodiment, the organic layer OLa may include a negative photosensitive material so that a portions corresponding to each of a light shielding area BP, a first transflective area TP1, and a second transflective area TP2 of a mask MK may become opposite.

The mask MK may be disposed above the organic layer OLa. The mask MK may include a light shielding area BP, a first transflective area TP1, and a second transflective area TP2. The light shielding area BP may not allow light to transmit therethrough. Each of the first transflective area TP1 and the second transflective area TP2 may allow light to partially transmit therethrough.

The first transflective area TP1 may be disposed between a first dam DM1 and a second dam DM2 on a plane. The second transflective area TP2 may be spaced apart from the first transflective area TP1 with respect to the second dam DM2 therebetween on the plane. The first transflective area TP1 and the second transflective area TP2 may not overlap the first dam DM1 and the second dam DM2 on the plane.

Light LT may transmit through the mask MK and be provided to the top surface OLa-U of the organic layer OLa.

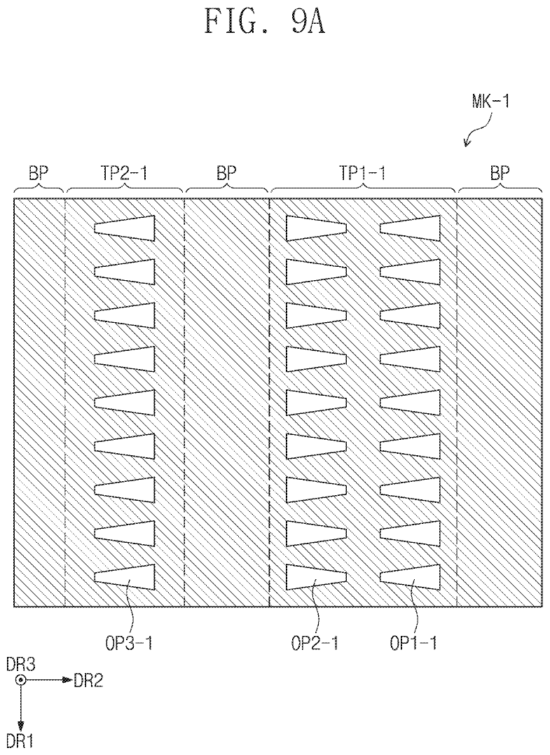

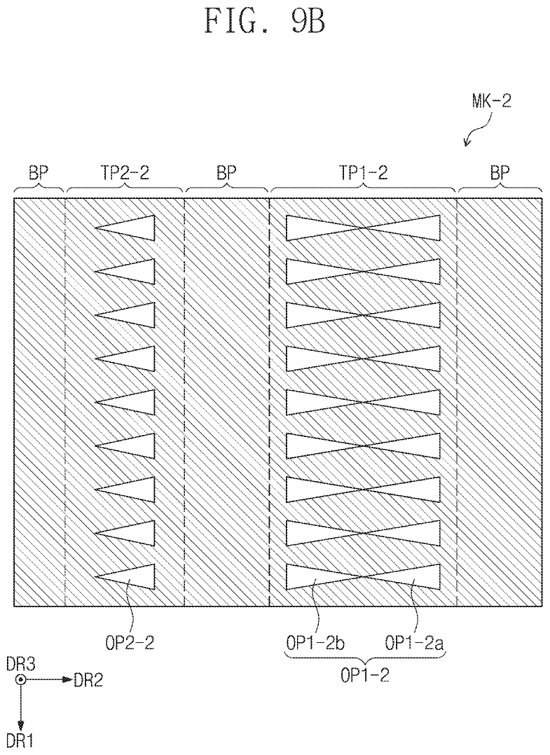

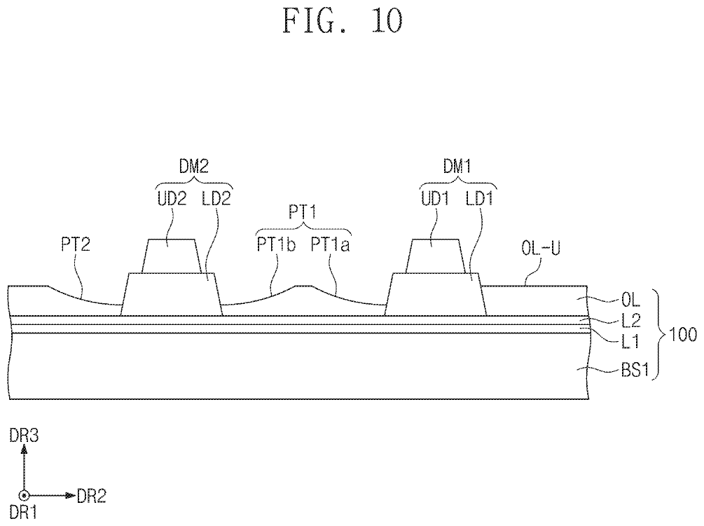

FIG. 9A is a plan view illustrating a mask according to an embodiment of the present disclosure.

Referring to FIGS. 8 and 9, a mask MK-1 in FIG. 9A may correspond to the mask MK in FIG. 8. The mask MK-1 may include first opening patterns OP1-1 and second opening patterns OP2-1 in a first transflective area TP1-1. The mask MK-1 may include third opening patterns OP3-1 in the second transflective area TP2-1. The mask MK-1 may be disposed so that the first opening patterns OP1-1 are disposed closer to the first dam DM1 than the second opening patterns OP2-1.

Each of the first opening patterns OP1-1 may have a width in the first direction DR1, which gradually increases in the second direction DR2. On a plane, each of the first opening patterns OP1-1 may have the width in the first direction DR1, which gradually increases in a direction adjacent to the first dam DM1.

Each of the second opening patterns OP2-1 may have a width in the first direction DR1, which gradually decreases in the second direction DR2. On the plane, each of the second opening patterns OP2-1 may have the width in the first direction DR1, which gradually increases in a direction adjacent to the second dam DM2.

Each of the third opening patterns OP3-1 may have a width in the first direction DR1, which gradually increases in the second direction DR2. On the plane, each of the third opening patterns OP3-1 may have the width in the first direction DR1, which gradually increases in a direction adjacent to the second dam DM2.

FIG. 9B is a plan view illustrating a mask according to an embodiment of the present disclosure.

Referring to FIGS. 8 and 9B, a mask MK-2 in FIG. 9B may correspond to the mask MK in FIG. 8. The mask MK-2 may include first opening patterns OP1-2 in a first transflective area TP1-2. The mask MK-2 may include second opening patterns OP2-2 in a second transflective area TP2-2. Each of the first opening patterns OP1-2 may include first sub-opening patterns OP1-2a and second sub-opening patterns OP1-2b. The mask MK-2 may be disposed so that the first sub-opening patterns OP1-2a are disposed closer to the first dam DM1 than the second sub-opening patterns OP1-2b.

Each of the first opening patterns OP1-2 may have a width in the first direction DR1, which gradually decreases and then gradually increases in the second direction DR2. Each of the first opening patterns OP1-2 may include first sub-opening patterns OP1-2a and second sub-opening patterns OP1-2b. On a plane, each of the first sub-opening patterns OP1-2a may have a width in the first direction DR1, which gradually increases in a direction adjacent to the first dam DM1. On the plane, each of the second sub-opening patterns OP1-2b may have a width in the first direction DR1, which gradually increases in a direction adjacent to the second dam DM2. On the plane, each of the first sub-opening patterns OP1-2a may have a triangular shape, and each of the second sub-opening patterns OP1-2b may also have a triangular shape.

Each of the second opening patterns OP2-2 may have a width in the first direction DR1, which gradually increases in the second direction DR2. On a plane, each of the second opening patterns OP2-2 may have a width in the first direction DR1, which gradually increases in a direction adjacent to the second dam DM2. On the plane, each of the second opening patterns OP2-2 may have a triangular shape.

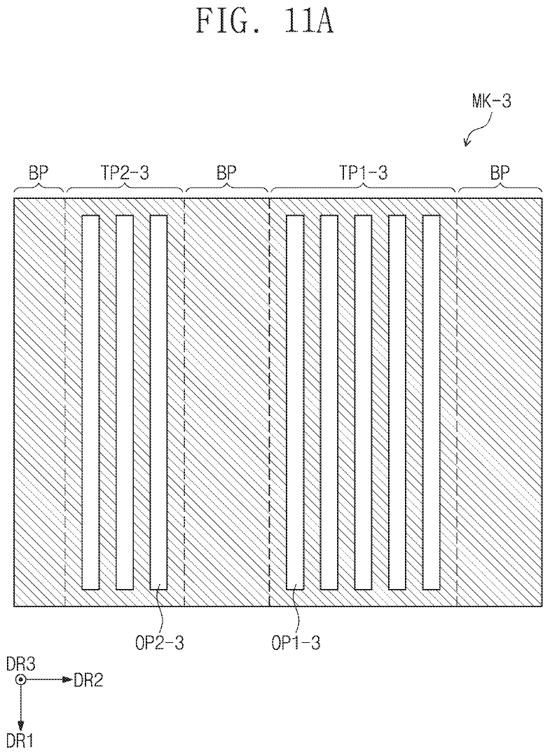

FIG. 10 is a cross-sectional view illustrating a first substrate in which an organic layer is patterned according to an embodiment of the present disclosure. The components described through FIG. 6 are designated by the same reference numerals, and description thereof is omitted.

Referring to FIGS. 8 and 10, a first pattern PT1 and a second pattern PT2 may be provided in an organic layer OL. The organic layer OL may be patterned by selectively exposing light LT using a mask MK. The mask MK may include the mask MK-1 in FIG. 9A or the mask MK-2 in FIG. 9B. The organic layer OL including the first pattern PT1 and the second pattern PT2 may be provided through a developing process.

Referring to FIGS. 9A and 10, the first opening patterns OP1-1 may overlap an area in which a first sub-pattern PT1a is defined on a plane. An area in which one portion of each of the first opening patterns OP1-1, which is adjacent to each of the second opening patterns OP2-1, is disposed may have a relatively low transmittance of the light LT (refer to FIG. 8), and the area in which the other portion of each of the first opening patterns OP1-1, which is adjacent to the first dam DM1, is disposed may have a relatively high transmittance of the light LT (refer to FIG. 8). The organic layer OL in which the first sub-pattern PT1a is defined may have a thickness that gradually increases from the first dam DM1 in the second direction DR2.

The second opening patterns OP2-1 may overlap the area in which second sub-pattern PT1b is defined on the plane. The area in which one portion of each of the second opening patterns OP2-1, which is adjacent to each of the first opening patterns OP1-1, is disposed may have a relatively low transmittance of the light LT (refer to FIG. 8), and the area in which the other portion of each of the second opening patterns OP2-1, which is adjacent to the second dam DM2, is disposed may have a relatively high transmittance of the light LT (refer to FIG. 8). The organic layer OL in which the second sub-pattern PT1b is defined may have a thickness that gradually increases from the second dam DM2 in the second direction DR2.

The third opening patterns OP3-1 may overlap an area in which the second pattern PT2 is defined on the plane. The area in which one portion of each of the third opening patterns OP3-1, which is adjacent to the second dam DM2, is disposed may have a relatively high transmittance of the light LT (refer to FIG. 8). The organic layer OL in which the second pattern PT2 is defined may have a thickness that gradually increases from the second dam DM2 in the second direction DR2.

According to an embodiment of the present disclosure, the first pattern PT1 may prevent the first alignment film ALN1 (refer to FIG. 6), which passes over the first dam DM1, from passing over the second dam DM2. Reduction in adhesive force of the sealing member SLM (refer to FIG. 6) and permeation of air or oxygen into the display device DD (refer to FIG. 1), which are able to be generated when the first alignment film ALN1 (refer to FIG. 6) is over-applied, may be prevented. Thus, the method for manufacturing the display device DD (refer to FIG. 1) having improved reliability may be provided.

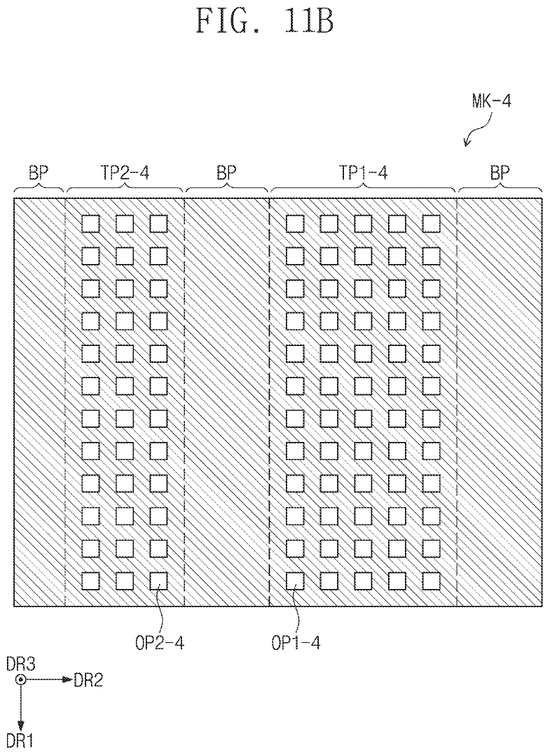

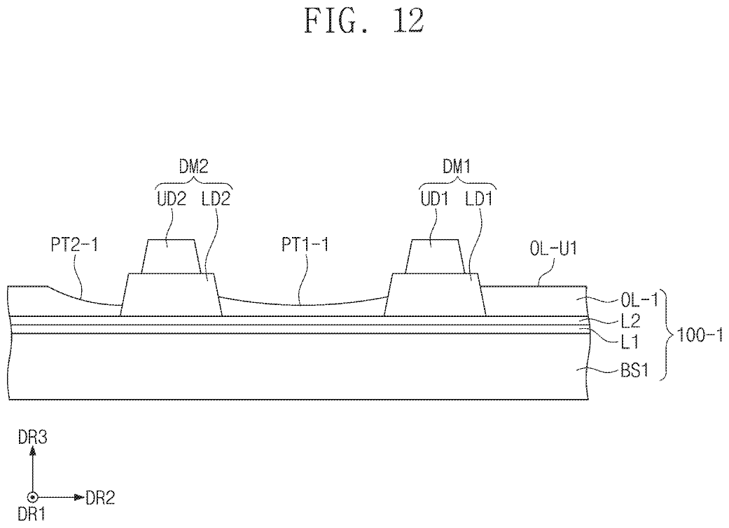

FIG. 11A is a plan view illustrating a mask according to an embodiment of the present disclosure.

Referring to FIGS. 8 and 11A, a mask MK-3 in FIG. 11A may correspond to the mask MK in FIG. 8. The mask MK-3 may include a first transflective area TP1-3 and first opening patterns OP1-3. The mask MK-3 may include second opening patterns OP2-3 in a second transflective area TP2-3.

Each of the first opening patterns OP1-3 may extend in the first direction DR1 and be spaced apart from each other in the second direction DR2. On a plane, each of the first opening patterns OP1-3 may have a bar shape.

Each of the second opening patterns OP2-3 may extend in the first direction DR1 and be spaced apart from each other in the second direction DR2. On the plane, each of the second opening patterns OP2-3 may have a bar shape.

FIG. 11B is a plan view illustrating a mask according to an embodiment of the present disclosure.

Referring to FIGS. 8 and 11B, a mask MK-4 in FIG. 11B may correspond to the mask MK in FIG. 8. The mask MK-4 may include a first transflective area TP1-4 and first opening patterns OP1-4. The mask MK-4 may include second opening patterns OP2-4 in a second transflective area TP2-4.

Each of the first opening patterns OP1-4 may extend in the first direction DR1 and be spaced apart from each other in the second direction DR2. On a plane, each of the first opening patterns OP1-4 may have a dot shape.

Each of the second opening patterns OP2-4 may extend in the first direction DR1 and be spaced apart from each other in the second direction DR2. On the plane, each of the second opening patterns OP2-4 may have a dot shape.

FIG. 12 is a cross-sectional view illustrating a first substrate in which an organic layer is patterned according to an embodiment of the present disclosure. The components described through FIG. 7 are designated by the same reference numerals, and description thereof is omitted.

Referring to FIGS. 8 and 12, a first pattern PT1-1 and a second pattern PT2-1 may be provided in an organic layer OL-1. The organic layer OL-1 may be patterned by selectively exposing light LT using a mask MK. The mask MK may include the mask MK-3 in FIG. 11A or the mask MK-4 in FIG. 11B. The patterned organic layer OL-1 including the first pattern PT1-1 and the second pattern PT2-1 may be provided through a developing process.

Referring to FIGS. 11A and 12, the first opening patterns OP1-3 may overlap an area in which the first pattern PT1-1 is defined on a plane. Each of the first opening patterns OP1-3 may have a constant transmittance of the light LT (refer to FIG. 8). The first pattern PT1-1 may have a concaved shape recessed from a top surface OP-U1 of the organic layer OL-1.

The second opening patterns OP2-3 may overlap an area in which the second pattern PT2-1 is defined on the plane. Each of the second opening patterns OP2-3 may have a constant transmittance of the light LT (refer to FIG. 8). The second pattern PT2-1 may have a concaved shape recessed from the top surface OP-U1 of the organic layer OL-1.

According to an embodiment of the present disclosure, the thickness difference TK1-1 (refer to FIG. 7) between the thickness of the second dam DM2 and the maximum thickness of the first pattern PT1-1 of the display device DD (refer to FIG. 1) serves as a dam to prevent the first alignment film ALN1 (refer to FIG. 7), which passes over the first dam DM1, from passing over the second dam DM2. The reduction in adhesive force of the sealing member SLM (refer to FIG. 7) and the permeation of air or oxygen into the display device DD (refer to FIG. 1), which are able to be generated when the first alignment film ALN1 (refer to FIG. 7) is over-applied, may be prevented. Thus, the method for manufacturing the display device DD (refer to FIG. 1) having the improved reliability may be provided.

According to the embodiment of the present disclosure, the first pattern defined in the organic layer may prevent the alignment film, which passes over the first dam, from passing over the second dam when over-applied. The reduction in adhesive force of the sealing member and the permeation of air or oxygen into the display device, which are generated when the alignment film is over-applied, may be prevented. Thus, the display device having the improved reliability and the method for manufacturing the same may be provided.

Although the example embodiments of the present disclosure have been described, it is understood that the present disclosure should not be limited to these example embodiments but various changes and modifications can be made by one ordinary skilled in the art within the spirit and scope of the present disclosure as hereinafter claimed. Hence, the real protective scope of the present disclosure shall be determined by the technical scope of the accompanying claims.

What is claimed is:

1. A display device comprising:
a first substrate comprising a display area in which a plurality of pixels are disposed and a non-display area disposed adjacent to the display area;
a second substrate disposed on the first substrate; and
a sealing member disposed between the first substrate and the second substrate,
wherein the first substrate comprises:
a first base layer;
a first dam disposed on the first base layer in the non-display area;
a second dam disposed on the first base layer in the non-display area and spaced apart from the first dam; and
an organic layer disposed on the first base layer,
wherein a first pattern, which is recessed from a top surface of the organic layer, is defined in the top surface of the organic layer, and the first pattern is provided between the first dam and the second dam.

2. The display device of claim 1, wherein the first pattern comprises a first sub-pattern and a second sub-pattern,
the first sub-pattern is disposed adjacent to the first dam,
the second sub-pattern is disposed adjacent to the second dam while being spaced apart from the first sub-pattern, and
each of the first sub-pattern and the second sub-pattern is recessed from the top surface of the organic layer.

3. The display device of claim 1, wherein the sealing member overlaps the second dam and does not overlap the first dam on a plane.

4. The display device of claim 1, wherein the first dam comprises a first lower dam and a first upper dam disposed on the first lower dam, and
the second dam comprises a second lower dam and a second upper dam disposed on the second lower dam.

5. The display device of claim 4, wherein the first upper dam has a width less than a width of the first lower dam, and
the second upper dam has a width less than a width of the second lower dam.

6. The display device of claim 4, wherein the first upper dam has a thickness less than a thickness of the first lower dam, and
the second upper dam has a thickness less than a thickness of the second lower dam.

7. The display device of claim 4, wherein the organic layer has a thickness less than a thickness of the first lower dam.

8. The display device of claim 1, wherein a second pattern recessed from the top surface is defined in the organic layer, and the second pattern is spaced apart from the first pattern with respect to the second dam.

9. The display device of claim 8, wherein the second substrate comprises:
a second base layer;
a first column spacer disposed below the second base layer and overlapping the non-display area on a plane; and
a second column spacer disposed below the second base layer and overlapping the non-display area on the plane while being spaced apart from the first column spacer.

10. The display device of claim 9, wherein the first column spacer overlaps the first pattern on the plane, and
the second column spacer overlaps the second pattern on the plane.

11. The display device of claim 9, wherein the first column spacer and the second column spacer do not overlap the first dam and the second dam on the plane.

12. The display device of claim 9, wherein the first substrate further comprises a first alignment film disposed on the first base layer, and the second substrate further comprises a second alignment film disposed below the second base layer.

13. The display device of claim 12, wherein the first alignment film overlaps the first dam and the first pattern on the plane and does not overlap the second dam and the second pattern.

14. The display device of claim 12, wherein the second alignment film overlaps the first column spacer and does not overlap the second column spacer on the plane.

15. A method for manufacturing a display device, the method comprising:
providing a first substrate comprising a display area in which a plurality of pixels are disposed and a non-display area disposed adjacent to the display area;
providing a second substrate disposed on the first substrate; and
coupling the first substrate and the second substrate by using a sealing member,
wherein the providing of the first substrate comprises:
providing a base layer;
forming a first dam on the base layer overlapping the non-display area;
forming a second dam, which is spaced apart from the first dam, on the base layer overlapping the non-display area;
forming an organic layer on the base layer; and
patterning the organic layer using a mask,
wherein the patterning of the organic layer comprises forming a first pattern, which is recessed from a top surface of the organic layer, in the top surface of the organic layer between the first dam and the second dam.

16. The method of claim 15, wherein the sealing member overlaps the second dam and does not overlap the first dam on the plane.

17. The method of claim 15, wherein the patterning of the organic layer further comprises forming a second pattern recessed from the top surface of the organic layer, and the second pattern is spaced apart from the first pattern with respect to the second dam.

18. The method of claim 15, wherein the forming of the first pattern comprises:
forming a first sub-pattern recessed from the top surface of the organic layer adjacent to the first dam; and
forming a second sub-pattern recessed from the top surface of the organic layer adjacent to the second dam,
wherein the first sub-pattern and the second sub-pattern are spaced apart from each other.

19. The method of claim 15, wherein the providing of the first substrate further comprises forming an alignment film on the organic layer.

20. The method of claim 19, wherein the alignment film overlaps the first dam and the first pattern and does not overlap the second dam.
